(19) United States
(12) Patent Application Publication
(10) Pub. No.: US 2007/0222399 A1
(43) Pub. Date: Sep. 27, 2007

(54) Energy saving extra-low voltage dimmer lighting system

(76) Inventors: Montgomery Bondy, Gibsons (CA); Allen B. Hepworth, Port Moody (CA); Brent McKee, Gibsons (CA); Richard J. Bentley, Port Moody (CA)

Correspondence Address: Paul D. Gornall;Registered Patent & TM Agent, 1820--355 Burrard St., Vancouver, BC, V6C 2G8, CA

(21) Appl. No.: 11/723,445

(22) Filed: Mar. 20, 2007

Related U.S. Application Data
(63) Continuation-in-part of application No. 10/999,917, filed on Dec. 1, 2004.

(51) Int. Cl. H05B 37/02

(52) U.S. Cl. 315/291

(57) ABSTRACT

A system of extra-low voltage outdoor lighting is disclosed in which any number of light fixtures each have an individual control module, internal to the fixture or external to the fixture. The control module allows for the use of a power supply transformer (120 volt AC) manufactured to supply power to the extra-low voltage secondary transmission conductors, ranging from 12 volts up to a maximum of 30 volts AC, thus in some instances carrying voltage which is significantly higher than standard to the said control module. Each extra-low voltage fixture of 12 volts is fed from this over-voltage transformer through extra-low voltage secondary transmission conductors and through the control module, which rectifies the supply voltage to DC and then regulates that same voltage. Further, the control module, which produces an output voltage to an extra-low voltage fixture, commonly 12 volts, can be set and reset according to desired light output by means of an accessible dimming control to a range of voltage from 12 volts DC (average) and below. The system is especially suited for garden and architectural lighting and the dimming of lamps therein, the result of which is energy conservation in several ways, as will be described. The control module will also function with DC inputs from 12 to 30 volts, such as alternate energy systems including solar power. In one embodiment, the individual light fixtures allow for the fitting of the above control module inside the fixture housing. The housing can be converted from an up-light to a down-light without tools with the inclusion of a light tube and mushroom cap. The control module and transformer can be utilized to upgrade extra-low voltage outdoor lighting systems and other manufacturer's fixtures already in use. The system allows for the dimming of LED (light emitting diode) lamps.

This is a Continuation-In-Part of prior U.S. patent application Ser. No. 10/999,917, “MULTIPLE DIMMER LIGHTING SYSTEM”, by the same inventors, Bondy et al.

### BACKGROUND OF THE INVENTION

1. Field of the Invention

This invention relates to extra-low voltage outdoor lighting, where variation in placement and brightness of individual lights may provide striking contrast of illumination of plants or buildings within a garden or other area, and where energy conservation is a desired outcome.

2. Description of the Prior Art

With respect to alternate existing dimming methods, there are none available on the market for extra-low voltage lighting at the time of this application. Prior to the Bondy et al design, attempts were made to find a practical and effective method for dimming extra-low voltage outdoor landscape fixtures, however as will be seen, none of the methods proved to have merit.

Using one method, a magnetic dimmer was placed in series with the 120 volt AC supply side of the power supply with 12-volt AC secondary transmission conductors. The result was not satisfactory. With wire runs in place the lamps dimmed unevenly; some with longer runs were so dim as to be totally ineffective. This occurred because, with this method, all conductors must be equal in resistance whether by length or AWG size. With this configuration of equal lengths of supply wire, all lamps dimmed equally and therefore did not produce the desired result since various light locations required differing light outputs. In fact, conductors could produce different levels of dimming if they were purposely cut to different lengths, which was a very complex process and only proved the power losses. Other problems included a very noisy power supply with attendant power losses. The conductor losses were very large with the most severe losses on longer runs. Since the supply was dimmed below 12 volts AC, the power losses ranged above 25 percent.

A second method was the utilization of a magnetic dimmer placed in series with a multi-tap transformer (120 volt AC). This resulted in better control for dimming but the over-voltage taps merely indicated how severe the power losses were. A 15 volt tap already indicates a 25 percent power loss if the result is 12 volts at the fixture. The use of the line voltage primary dimmer resulted in again far too much power loss. Precise control of lamp output was in every case a complex calculation. Again, with noise and heat losses in the transformer added to the other losses above, the power losses were over 25 percent.

A third method would be to place the dimmers at the power supply, but again the line losses were excessively high. The voltage through the secondary transmission conductors was low enough to cause as much undesired dimming effect in line losses as the dimmer itself.

The Bondy et al system overcame the above problems sufficiently well as to be called far superior.

A line voltage (120 volts AC) system could be made to function in a similar manner as the Bondy et al system but the expense would be exorbitant. Only a small percentage of end users could afford the material and installation costs.

We believe it is a great credit to the Bondy et al system to bring top end performance into the range of average homeowners' budgets, which is part of the commercial advantage of the invention. This was actualized along with keeping the system very simple for the end user to install. Lamp life will be lengthened by dimming and the quality components will serve for many years to come.

### SUMMARY OF THE INVENTION

An energy saving system of extra-low voltage outdoor lighting is provided in which a single or multitude of extra-low voltage light fixtures each have an individual control module which enables the setting of individual brightness for each lamp in either the singular or a plurality. Each individual control module (internal or external to the fixture) can be pre-set during installation or adjusted afterward. All manner of primary on/off switching is made possible by the growing market and, consequently, products that are being made available. For the purpose of this system of lighting the primary switching, whether by timer or photocell, etc, is beyond the scope of this invention since the system is affected by the secondary side of the extra-low voltage power supply. For the purpose of this invention most countries have what is called extra-low voltage weatherproof power supply transformers. The object of these is to allow laypersons having no prior training to install a system of lighting outdoors without the likelihood of anyone being injured. Most North American systems rely on power supply (120 volt AC) with secondary supply voltages of 12 volts. This voltage is also the rating of most available fixtures. Since, as is commonly known, household power generally is 120 volts to ground; the result is a 10-to-1 transformer. In a preferred embodiment, as stated in the Bondy et al prior application and herein disclosed in greater detail, the secondary voltage output that would be used would instead be 24 volts, resulting in a ratio of step down of 120 volts to 24 volts, or 5-to-1. It is trade knowledge that the closer the voltage of the primary winding to the secondary winding the less power is lost in the transition. This is one method of energy savings among many. Next in the Bondy et al system are the conductors used. We recommend in our system that conductors will be run as for the 12 volt systems. As it is commonly known in the trade that voltage drop in a conductor is directly related to load and voltage, the higher the voltage the lower the power loss. Since our system includes a secondary voltage of 24 volts then it follows that the percent drop will be cut in half. This is another energy saving component of our system. The output of the control module (made known in the detailed description) will be from 12 volts DC (average) down depending on dimming setting.

To elucidate for the remainder of this document, whenever 12 volt dimming is mentioned, the following description most accurately describes what occurs. Lamp brightness is controlled by adjusting the control pot, which then causes the circuitry to vary the duty cycle (on to off time) of the lamp. The result is that the lamp sees the average of the on-off time as a lower voltage and therefore does not light as brightly. For example, if the duty cycle is 50% (on half the time) when operated from a 12 volt supply, the lamp would see the average as 0.5×12=6 volts. This feature can also be used successfully to compensate for voltage variations due to conductor voltage drop and to allow the unit to be run from higher voltages than the 12 volts that the lamp is designed for without the lamp sustaining damage. Thus, when operated from a 24 volt supply, the lamp will have maximum brightness when the average voltage is 12 volts, which works out to 0.5×24=12 volts or 50% duty cycle. So, by allowing changes in the supply voltage to also change the duty cycle of the lamp power, brightness settings can be automatically maintained with variations in supply voltage.

Since the lights can be made to be as bright as necessary, and not more than this, is a further source of energy savings in our system. Yet another is the short length of the power conductors between the control module and the lamp when lower than 12 volts is applied, as is the case for dimming. Further, in another embodiment, as stated in the Bondy et al prior application and herein disclosed in greater detail, the use of LED (light emitting diode) lamps that have been color corrected would result in a much more efficient light source when compared to halogen lamps, which are commonly used in the extra-low voltage outdoor lighting market.

The system of extra-low voltage outdoor lighting can be made to operate from 12 volts to 30 volts AC. DC voltage can also be utilized. The control module will compensate for fluctuations and continue a light output as has been set. The control module has a memory and will reset the lamp output upon restarting. The preferred embodiment can handle loads to 50 watts. Future embodiments may have decreased or increased power-handling capacity.

In a preferred embodiment the control module would be mounted inside the spherical fixture. The latter would make the invention a one-piece unit for easy installation.

In other embodiments the control module could be made to control all manner of extra-low voltage light fixtures as long as the input of said fixtures is 12 volts. In all cases the voltage at the control module would necessarily be at least 12 volts. The control module is recommended for use with voltages exceeding 12 volts to the module.

Another preferred embodiment would be to have a system including an approved outdoor power supply transformer operating at approximately 24 volts AC and connected to a singular or plurality of extra-low voltage secondary transmission conductors:
a) all of which are connected to the control modules within the several fixtures for the purpose of dimming the included lamp to the desired light output;
b) all of which are connected to our control modules either inside our fixtures, or outside our fixtures but weatherproof and also connected to 12 volt fixtures of other manufacture;
c) all of which are connected to our weatherproof control modules and all controlling fixtures of other manufacture but rated at 12 volts.

In another embodiment our control module would be utilized purely as a dimmer and power loss reducer to upgrade existing outdoor lighting systems. Areas where light output is too bright could then be dimmed. In the main, a power supply transformer (120 volt AC) would be required with secondary voltage of 24 volts, or a multi-tap transformer ranging above 12 volts AC and approved for outdoor use.

The invention thus comprises a system of extra-low voltage outdoor lighting where the main power switch turns on and off the system by energizing or de-energizing the primary conductors to the hereafter approved extra-low voltage transformer. When energized the said transformer's secondary output is a nominal 24 volts. The secondary transmission conductors are connected to the secondary terminal of the transformer and run either underground, under sod, along fence boards or whatever the case may be to the said control modules. The control module has input and output terminals and the said 24 volt conductors are connected to the input terminals. The control module then rectifies the incoming power, and then regulates the incoming power down to 12 volts. The control module then allows the voltage to be dropped or again raised as is needed for the purpose of attaining the desired light effect from a lamp. For this purpose the control module has a weatherproof means to allow for the latter adjustment. The lamp is connected to the output terminals of the control module by means of short (5′) power conductors. After installation the said weatherproofed control can be adjusted as often as desired by the end user.

In a further preferred embodiment:
a) the control module first rectifies, then regulates, and then dims the power supplied to the extra-low voltage light fixture;
b) power at 24 volts AC is supplied along electrical conductors that would typically be used for 12 volts AC, and is then stepped down by the control module to 12 volts DC to the light fixture, whereby power loss over the electrical cable is approximately halved;
c) in addition to stepping power supply voltage down from 24 volts AC to 12 volts DC, the control module provides for selectable further reduction of voltage to the fixture as desired for dimming lighting effects and further energy savings;
d) an extra-low voltage control module including an outdoor extra-low voltage lighting regulator, rectifier, and dimmer operating exclusively between 4 and 30 volts AC and DC, is used;
e) the control module is encased in a weatherproof housing and has an accessible dimming control which can be used to further reduce power consumption from 12 volts DC down and enhance outdoor lighting effects;
f) the control module will fit inside a substantially spherical fixture with or without a convertible mushroom cap;
g) the light fixture allows for rapid conversion of from up-light to down-light by means of a tube and a mushroom shaped canopy.

Another preferred embodiment would be to use the system with individually dimmed lights, in which:
a) the power supply transformer, which is rated for extra-low voltage outdoor use, has secondary power terminals rated at 24 volts;
b) the secondary transmission conductors would be of sufficient capacity to carry the current if the conductors were instead sized for the standard 12 volts;
c) the control modules are placed for easy access and have outputs from 12 volts and below;
d) the fixtures contain lamps rated for 12 volts;
e) the fixtures are spherical and can be easily converted from up-lights to down-lights;
f) the above control module and fixture are constructed as to allow for LED (light emitting diode) lamps.

With regard to long life energy saving lamps, the Bondy et al system can utilize LED (light emitting diode) lamps. We found the multiple LED white 12 volt par 36 lamps can also be dimmed by means of an altered dimming component of our control module. In the current environment encouraging a reduction in power consumption, alternative lighting sources are becoming available. The efficiency of a standard incandescent lamp is around 3%, which means that 97% of the energy used by the lamp comes out as heat. Halogen lamps have a higher efficiency, but the latest generation of high power LED (light emitting diode) lamps has an even higher efficiency. Below are given the differences between using a high power LED lamp instead of a halogen lamp.

If a high power LED lamp was used instead of a 36 watt halogen lamp, the power consumption would be reduced for the same level of light output.

On the present circuitry, the brightness of the halogen lamp varies slightly if the supply voltage is changed over a wide range. The voltage regulator circuitry required for the LED lamp, as described further below, would ensure a steady light output irrespective of the voltage input range. Lamp brightness level would be solely dependent upon the setting of the dimmer control.

When being dimmed, the light produced by a halogen lamp turns from white through yellow and gold. White LED lamps tend to be a blue white color and when dimmed stay the same color and just produce less light. For an LED lamp to produce a similar color shift to the halogen lamp when dimmed would require a red and yellow LED mix, which would dim at a slower rate and therefore make the light shift more to yellow-gold at lower light output levels.

LED lamps can be damaged and fail due to overheating, and high power LED lamps are mounted on a heat sink to aid cooling.

LED lamps can be dimmed in the same way as halogen lamps by varying the on-off time of the lamp; however, the present circuitry for the halogen lamp is not utilized. The peak current through a LED is strictly controlled to prevent failure of the individual LEDs. The LED lamp requires a power supply that produces a steady voltage, and this is achieved by the use of a switching regulator. Operating voltage range is similar to the presently shown embodiment.

After testing LED (light emitting diode) lamps of other colors, we determined that the required lamp must be made up of a configuration of different color LED emitters to form one lamp, so that by means of carefully mixing red, yellow, and white LED emitters, the outcome would be an eye-pleasing color at all dimming power levels. Unlike halogen lamps, LED lamps (in the main) do not change color when dimmed. Thus if the color mixture is pleasing at full rated power, then as power and consequently light output are reduced, then the color will remain substantially the same.

A glass refractory lens is made to both dissipate heat and mix the various colored LED emitters into one homogenous color output.

The combination of the LED control module and the LED lamp results in a very long life expectancy for both components. Since some existing par 36 LED lamps draw only 0.5 amps then many other layouts become possible in order to save substantial energy when compared to the halogen embodiment. In short 0.5 amps will produce substantially more lumens in a LED configuration than a halogen configuration.

In the preferred embodiment the LED control module and the LED lamp could be packaged and sold together as this would allow for finer tuning of the LED control module and LED lamp as described. The uppermost in energy savings potential will be the result of the latter.

This system of outdoor lights that are buried but shining upward to illuminate trees and shrubs, etc., and can be complemented by having some of the individually dimmable lights equipped with housings that each have a ledge and a rim surrounding a lens for a lamp. The ledge and rim are used to support and hold the cylindrical walls of a column supporting a mushroom cap shade that captures light energy shining up from the lamp and reflects it downward.

The Bondy et al system has been designed to cover the needs of up-lighting and down-lighting by means of the so-called mushroom cap and variable light output. The variable light output is made possible by the control module. Other fixtures from other manufacturers can be chosen as long as the control module is utilized to protect the lamp from over voltage. The end user can very simply lay out the system in the following way.

Having decided what locations are to be lighted for security, safety, and/or beauty, the fixtures are laid out at suitable locations. The power supply transformer (120 volts AC) is placed where it can be supplied with line voltage. Suitable conductors are run. The described fixtures are placed and/or the control modules with fixtures of other manufacture are placed. All connections are made. The entire system is energized during day to ensure proper installation.

After dark, by means of the control modules, some or all of the fixtures in the system can be dimmed according to the desire of the end user. Each setting can be adjusted again and again or altered for special occasions.

In the above description it is said that all the lamps may be dimmed. They might also be left at the highest setting. We have found that in most installations the 50 watt halogen described in one embodiment is too bright when set on high, and that the light output of these lamps can be softened in color when dimmed even slightly, thus creating a more aesthetically pleasing lighting outcome, which is one of the commercial advantages of the Bondy et al system. The 50 watt halogen described is very close in output to an automobile headlamp, and this upper end high quality lamp has been chosen because it is hoped that the lamp will be dimmed. Further, these relatively high output lamps with the control module compare favorably to components in very much more expensive commercial systems.

Power can be conserved by choosing the lowest light setting while still providing the desired light output. It is also hoped that the above lamp will be dimmed at least slightly because lamp life can be greatly increased in this manner.

Another embodiment of the Bondy et al system that might be included in the overall lighting plan would be the use of the control module to control a daisy chain string of lamps of other manufacture. Since the control module will safely control 50 watts then several (7) of the typical 7 watt pagoda light fixtures could be utilized. Or, as the case may be, any combination of available fixtures up to 50 watts.

In the preferred embodiment a 50 watt control module is utilized, however the control module is not limited to that power range and could be constructed to control smaller or larger loads.

In another embodiment, as described in the Bondy et al prior application and herein disclosed in greater detail, the control module will also function with DC inputs from 12 to 30 volts, such as alternate energy systems including solar power. Many alternate energy systems make use of a battery or battery array. A common voltage for these arrays is 24 volts DC. The control module will accept voltages between 12 and 30 volts DC. For this reason the Bondy et al system can be operated with such alternate energy systems (off the grid). One problem associated with simple alternate energy systems is voltage fluctuations. A 12 volt DC battery can be brought up above 13 volts DC while charging, which can result in lamps burning out. The Bondy et al control module levels out this fluctuating voltage and this results in much longer lamp life. Where National Electrical Code allows, the Bondy et al system could be utilized indoors in alternate energy homes.

With respect to energy conservation, at the present time efforts are being made all over North America and the world to reduce energy use and eliminate wasted consumption of power. It could be said that this is a top priority since our future and the future of generations to come will be affected by what we are able to do now to address this problem.

Pertaining to the design of the Bondy et al system, the following detailed explanation will clarify the magnitude of the energy savings available.

Where outdoor lighting is required or desired, and will be installed and utilized, our system offers several methods of reducing to a minimum the energy required to do so, as follows:
a) the ratio of the step down transformer is reduced from 10-to-1 to 5-to-1;
b) the reduction of power losses caused by voltage drop in the secondary transmission conductors;
c) placing the control module in close proximity in, at or near each light fixture, further reducing line losses;
d) dimming the light output of the lamps to what is desired or required by the end user, which also extends lamp life;
e) another embodiment of the control module is utilized to supply and/or dim LED lamps, which have been color-corrected by the use of a configuration of multi-color LED emitters;
f) the control module will also function with DC inputs from 12 to 30 volts, such as alternate energy systems including solar power.

Some existing available systems will not produce full lamp output. It is our contention that many systems are malfunctioning from the start regarding rated voltage and expected output and lamp life. Any attempt to cause dimming at the 12 volt supply will result in even larger power losses.

It is our hope that do-it-yourself extra-low-voltage outdoor lighting systems will come under a regulation authority. Consumers should be made aware of the unseen energy waste, which might occur with some of these systems. In some instances, kits sold by other manufacturers cause early lamp failure in the first lamp in closest proximity to the power supply transformer. The next lamp in line is often next to fail, etc., because the voltage may exceed 12 volts and there is nothing to protect the lamp under this condition.

What follows is a comparison of the energy saving performance of the Bondy et al system as described, with an existing system.

For the first comparison, the length of secondary transmission conductors used will be 200 feet. The size of the conductors will be #12 AWG. The lamp used will be a 12 volt 35 watt halogen par 36, nominal current 3 amps.

For the standard outdoor supply voltage of 12 volts, the percent voltage drop in existing systems is 16.33 percent, giving 10.04 volts at the fixture. It follows that the voltage drop is 1.96 volts. In this example there is an under voltage occurring and the lamp cannot be operated to rated power. This is not a reasonable outcome; however, these outcomes occur regularly with standard do-it-yourself extra-low voltage outdoor lighting systems. If a dimmer is located at the power supply then as the voltage is reduced the power losses will be increased.

For the Bondy et al system design the supply voltage will be 24 volts; the percent voltage drop is 8.16 percent, giving 22.04 volts at or very near the fixture. It follows that the voltage drop is 1.59 volts.

The under voltage situation has been eliminated, and with the use of the regulator in our system, the voltage will in all cases be 12 volts nominal at full power and dimming can be made to occur through 100 percent of the desired light output range of the chosen lamp.

Regarding conductor size, #12 AWG is at the top end for outdoor rated zip cord wire and is at the top of the range for stranded outdoor approved cable found in large building supply outlets. For larger sizes there is NMWU; however this cable is marketed primarily to licensed electricians.

For the second comparison, the length of the secondary transmission conductors used will be 100 feet. The size of the conductors will be #12 AWG. The lamp will be 12 volt 35 watt halogen par 36, nominal current 3 amps.

For the standard outdoor supply voltage of 12 volts, the percent voltage drop is 8.16 giving 11.02 volts at the fixture. It follows that the voltage drop is 0.98 volts. In this example there is again an under voltage at the lamp. The lamp cannot be operated through its full range. If a dimmer is located at the power supply then as the voltage is reduced the power losses will be increased.

For the Bondy et al system design, the supply voltage will be 24 volts; the percent voltage drop is 4.08, giving 23.02 volts at or near the fixture. Voltage drop is 0.98 volts

With existing systems, unless the secondary transmission conductors can be kept very short then the 12 volt supply will not provide the full range of the lamp capacity. Power losses increase significantly as the length of the secondary transmission conductors increases. Again, if dimming is made to occur at the power supply then the voltage drop will be further increased because lower supply voltages correspond to increased power losses.

It may be considered that 100 feet of secondary transmission conductors is excessive and is too long to be relevant, however this distance is common. It is instead the fault of some manufacturers who include far too little length of secondary transmission conductors to make professional-looking outdoor lighting a real possibility by end users.

According to the 2000 census, there are over 100 million housing units in the United States. (According to the U.S. Census Bureau, the 2000 census listed 115,902,572 housing units, and the estimated number of housing units in 2005 was 124,521,886. Source: www.census.gov.) We do not have an accurate percentage of homes that make use of some form of extra-low voltage outdoor lighting system, nor do we know the future rate of growth in the sales of do-it-yourself extra-low voltage outdoor lighting systems, however, trends to observe are the increase in consumer spending on outdoor lighting (for security, aesthetics, and enhanced market value), the growth in the residential construction industry, and the expansion in the environmental horticulture industry, also known as the “Green Industry”, which is comprised of a variety of businesses involved in production, distribution and services associated with ornamental plants, landscape and garden supplies and equipment.

There are demographics that show an increase in the number of people who will retire from work due to an aging population. As a group, many retirees very often turn to gardening and beautifying the outdoor portion of their property.

Growth in the outdoor lighting market will be further stimulated by efforts to increase the energy efficiency of new and existing lighting systems, generating residential landscape remodeling and upgrading activities, and non-residential retrofit projects. The growing focus on energy efficiency will also increase demand for high-efficiency products as well as for advanced technologies such as LEDs (light emitting diodes).

Commercial outdoor lighting can also be upgraded by means of the implementation of the Bondy et al system, by means of 50-watt halogen or LED lamps, a result that would be made possible because of the quality and durability of the Bondy et al system.

We estimate that there is, at a minimum, 1 house in 20 that makes use of an extra-low voltage lighting system. Thus, we estimate a minimum of 5 million homes making use of some type of extra-low voltage residential lighting system. Again, we estimate that these numbers will grow.

As we have indicated, the Bondy et al system can be amalgamated into almost all existing systems, both to reduce energy use and also to improve the function of these existing systems. The performance of the Bondy et al system will allow for an ever-increasing market share in the next ten years and beyond. The following indicates an estimate of energy savings made possible by the Bondy et al system.

Using the figure of 5 million homes over the period of 10 years indicates the following:

Where the average existing system consumes 200 watts of energy, it is estimated that with the Bondy et al system, 50 watts of energy might easily be saved at each location giving the following calculation:
50 watts×5 hours “on” time=250 watts or 0.25 kilowatt hours
0.25 kilowatt hours×365 days×5 million homes×10 years=4,562,500,000 kilowatt hours=4.562 gigawatt hours

If the 200 watt consumption seems high, it should be noted that this includes line voltage lighting fixtures attached to buildings or homes, such as floodlights.

We believe that this is a very low estimate of the results of using our system design.

Further energy savings can be obtained by the use of LED (light emitting diode) lamps, as described above in this document. With a color corrected combination of which, when dimmed, will produce similar lighting effects to those of the halogen type, the energy savings beyond go beyond what has been estimated above.

Finally, with the future in mind, the Bondy et al control module will also function with DC inputs from 12 to 30 volts, such as alternate energy systems including solar power, as described above.

There are different types of pollution, one of which is light pollution, i.e., excessively bright light fixtures which operate from dusk until dawn, in some cases blotting out the stars in the sky. The Bondy et al system design will reduce to a minimum light output for function and beauty, which will both reduce light pollution and increase quality of life.

To summarize, this invention provides a system of lighting for energy saving and for providing variably lighted landscapes and walkways, enabling end-users to install and create variable intensity outdoor lighting effects without the use of 120 volt AC (line voltage) fixtures, without running line voltage power transmission conductors or extension cords in moist and difficult ground conditions, and without needing skilled electricians, electrical permits, or extensive excavation to line voltage electrical codes, in which an over-voltage power supply is provided from an extra-low voltage outdoor transformer through a control module and then to an extra-low voltage outdoor light fixture.

### BRIEF DESCRIPTION OF THE DRAWINGS

There are 12 Figures, numbered 1A, 1B, 2, 3, 4, 5, 6, 7, 8, 9, 10 and 11.

FIG. 1A illustrates the configuration of one embodiment of the Bondy et al system, and FIG. 1B illustrates the configuration of the embodiment of FIG. 1A with additional detail, and also illustrates the configuration of two other embodiments of the Bondy et al system.

FIG. 2 illustrates the layout of the control module circuitry.

FIG. 3 illustrates the components of the light fixture and lamp.

FIGS. 4 and 5 illustrate the components of the light fixture and lamp in greater detail.

FIG. 6 illustrates the light fixture and lamp with a mushroom shaped cap (shade and reflector) fitted onto the light fixture housing.

FIG. 7 illustrates different illumination effects achieved by dimming individual lamps with the dimmer control component of the control module.

FIG. 8 illustrates the weatherproof embodiment of the control module.

FIG. 9 illustrates the configuration of a multi-coloured emitter LED lamp.

FIG. 10 illustrates the layout of the control module circuitry for usage with a LED lamp.

FIG. 11 illustrates a solar power embodiment of the Bondy et al system.

### DETAILED DESCRIPTION OF THE DRAWINGS

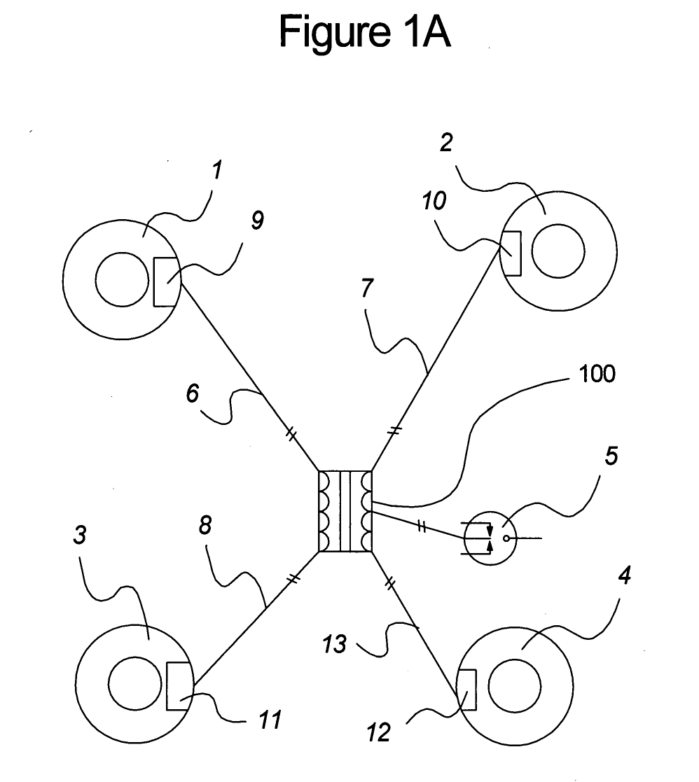

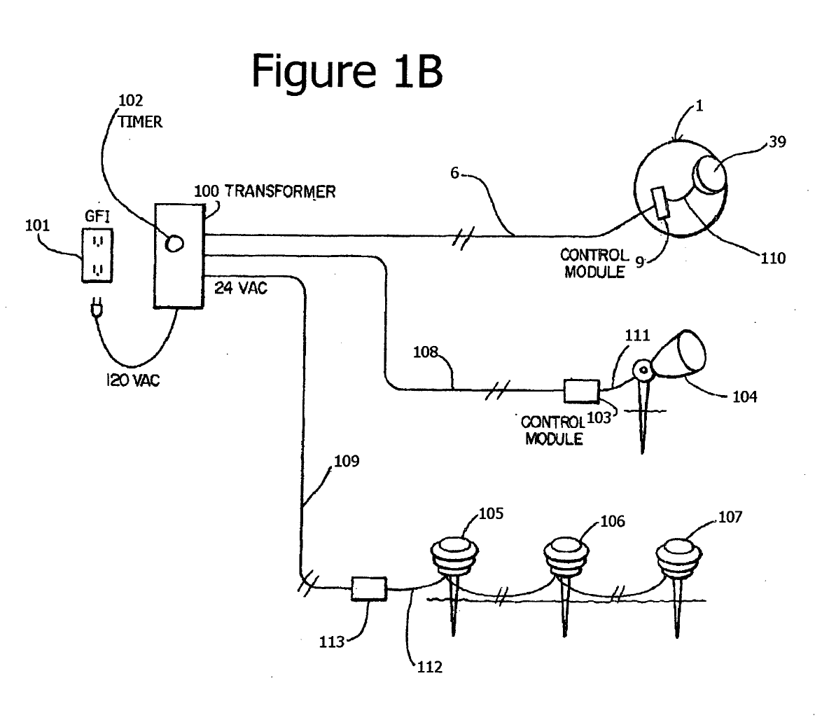

Referring to FIG. 1A, the configuration consists of a first individual light fixture 1, a second individual light fixture 2, a third individual light fixture 3, a fourth individual light fixture 4, each with its own control module (internal to the light fixtures 1, 2, 3, 4) 9, 10, 11, 12 respectively, which are connected to a power supply transformer (120 volts AC) 100 by extra-low voltage secondary transmission conductors 6, 7, 8, 13 respectively. The power supply transformer (120 volts AC) 100 is connected to a central primary line on/off control switch 5.

Referring to FIG. 1B, three embodiments of the Bondy et al system are illustrated. In all 3 configurations, the power supply transformer (120 volts AC) 100 is plugged into a GFI receptacle 101 and is switched on and off by a rotary timer 102, which is built into the power supply transformer (120 volts AC) 100.

In FIG. 1B, the configuration of the first and preferred embodiment consists of the power supply transformer (120 volts AC) 100 connected by extra-low voltage secondary transmission conductors 6 to the control module 9 (internal to the light fixture 1). The control module 9 is connected to the lamp 39 within light fixture 1 via extra-low voltage power conductors 110.

In a multi-fixture configuration of this preferred embodiment, as illustrated in FIG. 1A described above, additional light fixtures 2, 3, 4 with their own individual control modules (internal to the light fixtures 2, 3, 4) 10, 11, 12 are added and connected to the power supply transformer (120 volts AC) 100 with extra-low voltage secondary transmission conductors 7, 8, 13.

In FIG. 1. B, the configuration of the second embodiment consists of the power supply transformer (120 volts AC) 100 connected by extra-low voltage secondary transmission conductors 108 to the control module (external to the light fixture) 103 in close proximity to an extra-low voltage light fixture 104 of other manufacture, in which the lamp does not exceed 50 watts. From the external control module 103, power is fed to the lamp within the light fixture 104 via extra-low voltage power conductors 111.

In FIG. 1B, the configuration of the third embodiment consists of the power supply transformer (120 volts AC) 100 connected by extra-low voltage secondary transmission conductors 109 to the control module (external to the light fixture) 113 in close proximity to a daisy chain of extra-low voltage light fixtures 105, 106, 107 of other manufacture, the lamps within the said light fixtures not exceeding 50 watts total. From the external control module 113, power is fed to the lamps within the daisy chain of light fixtures via extra-low voltage power conductors 112.

Any combination of the three embodiments in FIG. 1B, and not restricted to only these embodiments, could be utilized in a single landscape design.

In FIG. 1B, the power supply transformer (120 volt AC) is switched on and off by a rotary timer 102. The said transformer 100 can be controlled by other components but for illustration purposes we have used a rotary timer.

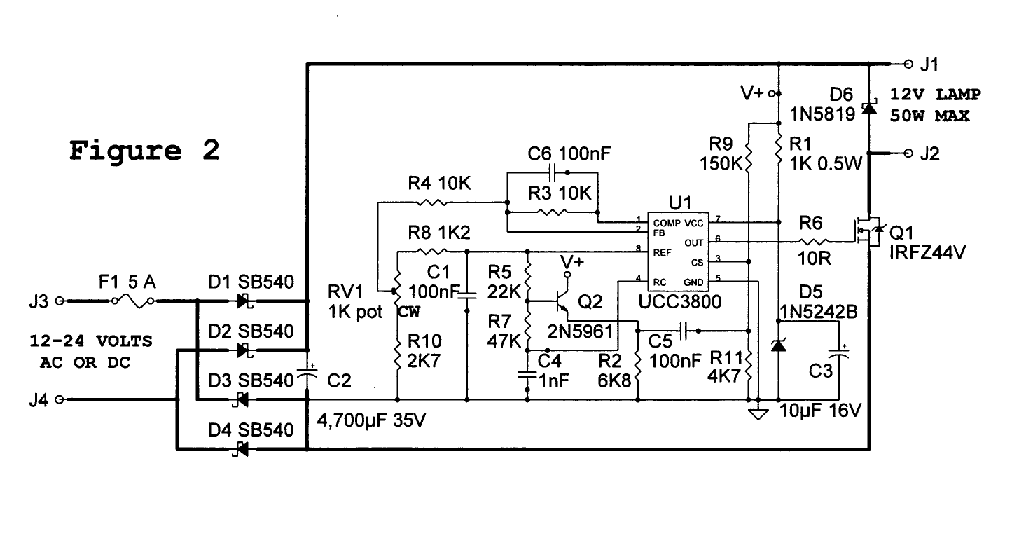

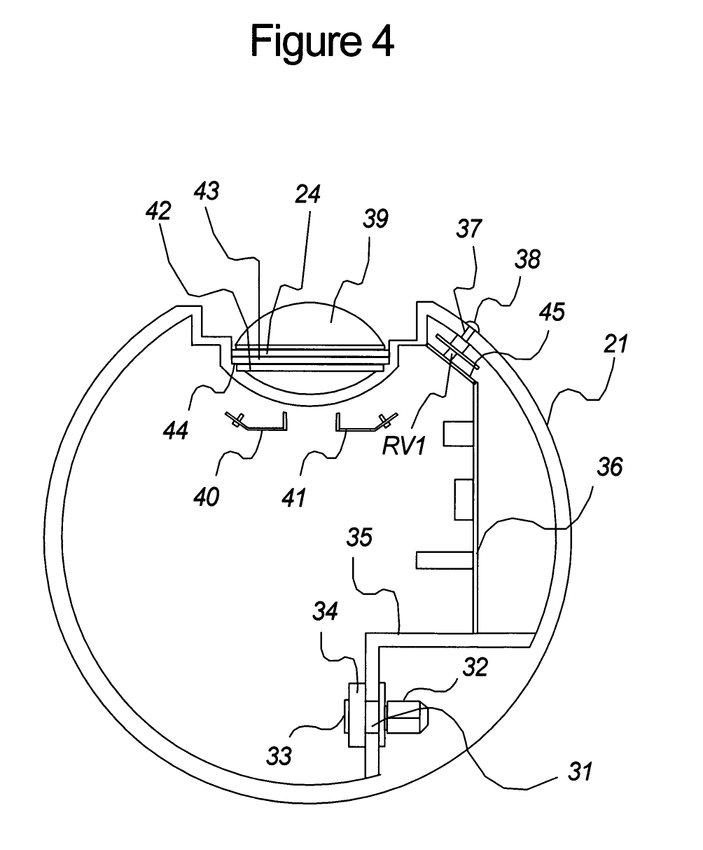

Referring to FIG. 2, this is a drawing of the circuitry of the control module board FIG. 4-36, which in this embodiment is rated for 50-watt loads or lamps. The lamp brightness is controlled by a switching circuit in integrated circuit (IC) U1 which controls the lamp start and varies the duty cycle of the power through Q1. The dimming level is set with screw adjuster pot RV1 which is rated 1K 20% 250 mW. This affects the lamp on time and hence the light output. To minimize lamp brightness changes with minor voltage flow variations, the supply voltage is sensed through the divider comprising R9 and R11.

Further electrical components complete the required circuits as shown in FIG. 2. C1, C5 and C6 are 100 nF monocap 50 V 20%; C2 is 4,700 uF Electrolytic 35V 20%; C3 is 10 uF electrolytic 16V. Diodes D1-D4 are 5 amps, 40 V; D5 is 12V 5% 500 mW; D6 is 1 Amp, 40 V. R1 is 1K 5% 500 mW. R2-R11 are all 5% 250 mW; with values R2—6K8, R3 and R4—10K, R5—22K, R6—10R, R7—47K, R8—1K2, R9—150K, R10—2K7, R11—4K7. Fuse F1 is a fast 5 amp fuse, mounted in fuse clip HW1 on the dimmer control board 20, which comprises a printed circuit board HW2. HW3 is a heat sink to dissipate excess heat during operation to allow the components to function without degradation due to overheating. Q1 is an FET rated at 60V 55 A and Q2 is a general purpose transistor 60 V 100 mA A current mode controller at U1 has a 100% duty cycle and is rated to operate in the range of 0- to 70 degrees C.

J3 and J4 are input terminals for inputs of 12 to 30 volts AC or DC. J1 and J2 are output terminals for outputs to the light fixture FIGS. 1A-1, 1B-1 containing the 12 volt lamp FIGS. 1B-39, 4-39, 5-39.

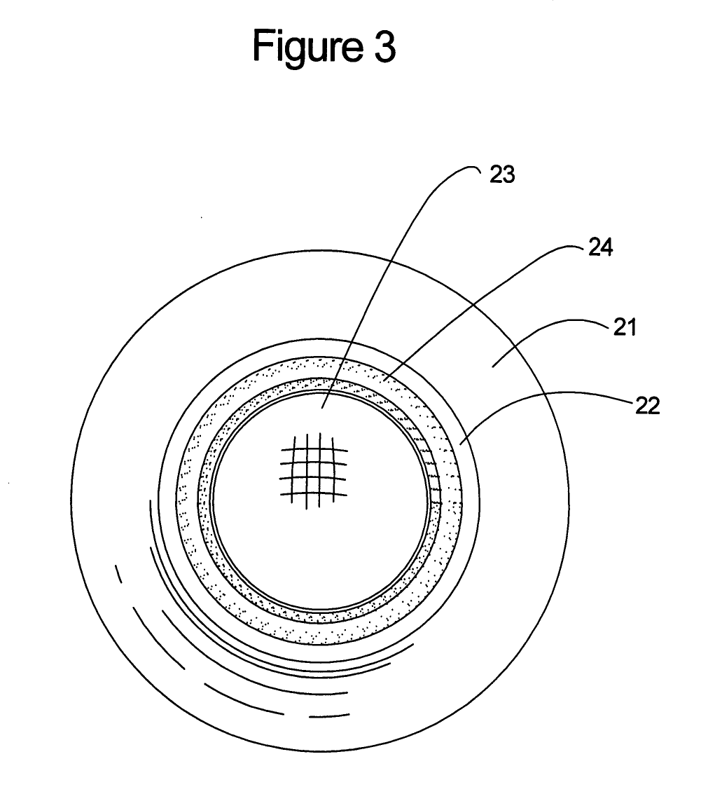

Referring to FIG. 3, the lamp has a substantially spherical fixture housing 21, which is weatherproof, suitable for burying such that only a top portion 22 adjacent to the lens cover 23 is exposed to shine on the target objects to be illuminated. The lens rim seal 24 keeps rain and dust from entering the fixture housing 21.

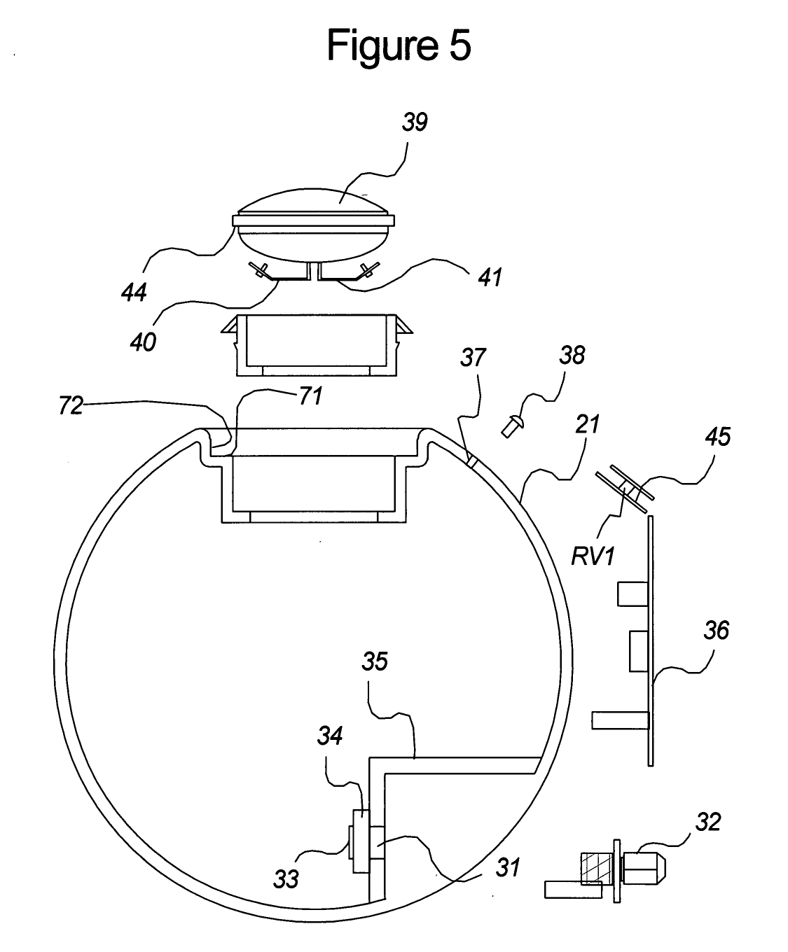

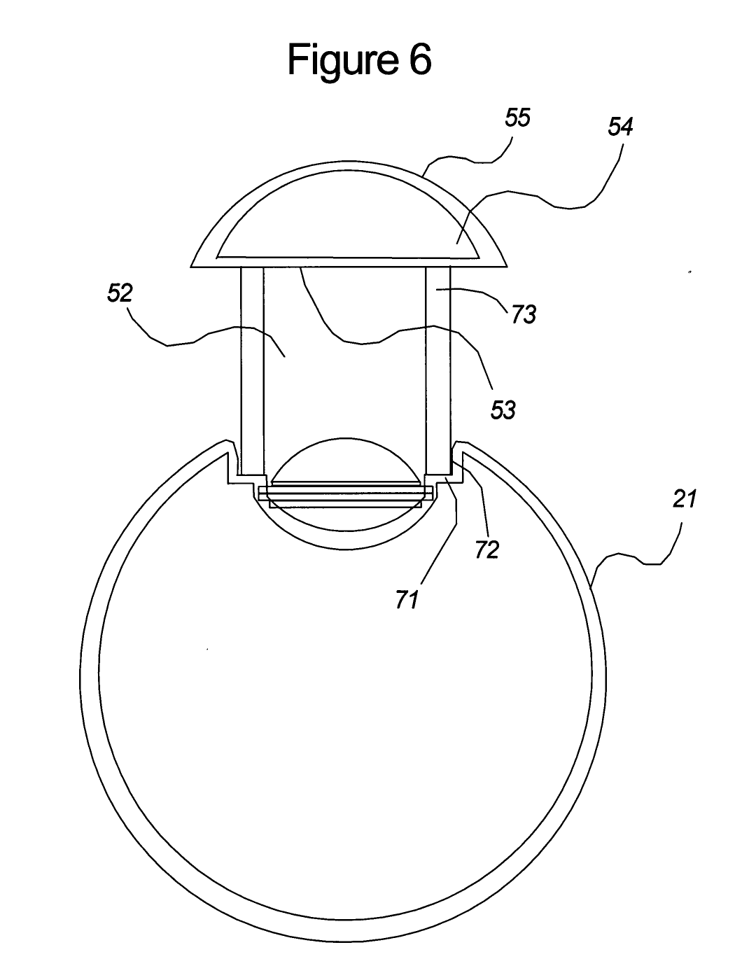

Referring to FIGS. 4 and 5, the fixture housing 21 has a wire inlet 31, a wire inlet grommet 32, adapted to seal around an electrical supply wire and match the weatherproof functionality of the fixture housing 21, a wire inlet bolt 33, and a complementary nut 34. The wire inlet bolt 33 also serves to hold the bottom flange 35 of the control module board 36. The dimmer's screw adjuster pot RV1 is set on an upper side flange 45 of the control module board 36 to enable to be positioned behind adjuster aperture 37. A dimmer screw adjuster plug 38 fits into the aperture 37 to seal against rain and dirt, etc. A sealed beam lamp 39, with electrical contacts 40 and 41 fits within the sealed beam cradle 42. The cradle is held in position in the fixture housing 21 by means of compression flange 43. The lens rim seal 24 can be made of resilient material of a close-fitting tolerance pressed into position on the lens seal rim ledge 44. The fixture housing 21 has an optional shade support ledge 71 and shade holding rim 72, suited to hold a shade wall FIG. 6-73. Thus, in place of a flush lens seal, a mushroom shaped shade and reflector can be fitted onto the fixture housing 21 as shown in FIG. 6. The mushroom shade and reflector 51 (not numbered in FIG. 6, but consisting of items 52, 53, 54, 55 and 73) has a hollow column 52 up which the light from the lamp travels. Slots in the column near its top allow the light to then be reflected down from the underside 53 of the mushroom-shaped cap 54. The top of the mushroom-shaped cap 55 acts as a roof or umbrella to deflect rain, wind, dust, and snow from falling on the lamp.

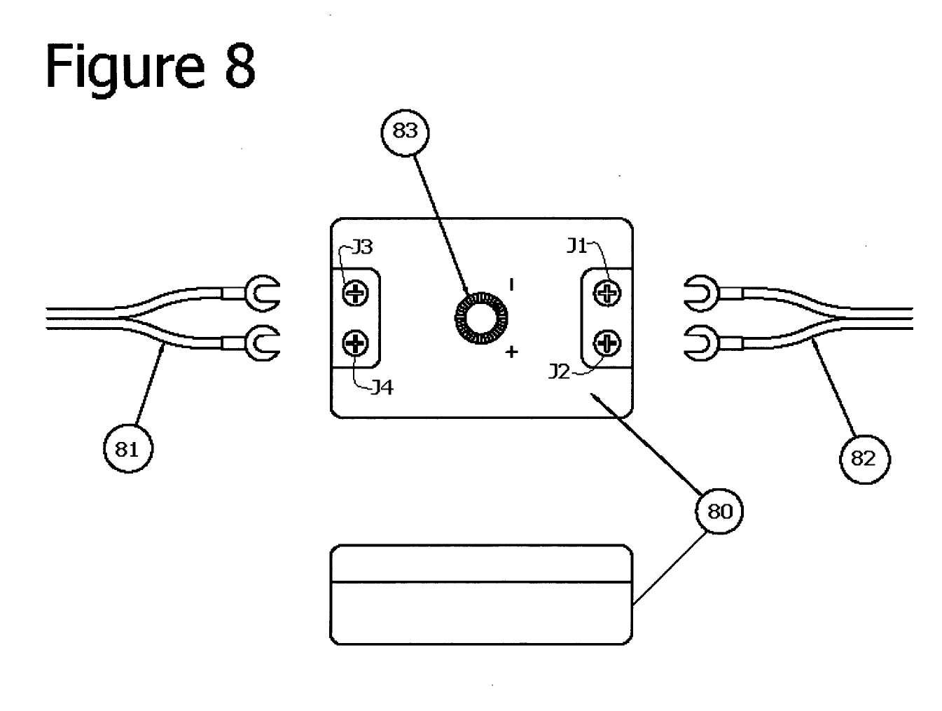

Referring to FIGS. 4 and 5, in this embodiment the control module board 36 is not enclosed in a weatherproof case FIG. 8-80 (to be described in FIG. 8), because the control module board 36 is enclosed in the weatherproof fixture housing 21. In a preferred embodiment, the control module board 36 will be enclosed in a weatherproof case FIG. 8-80, which will make the control module FIG. 1A-9 universal as shown in FIG. 8.

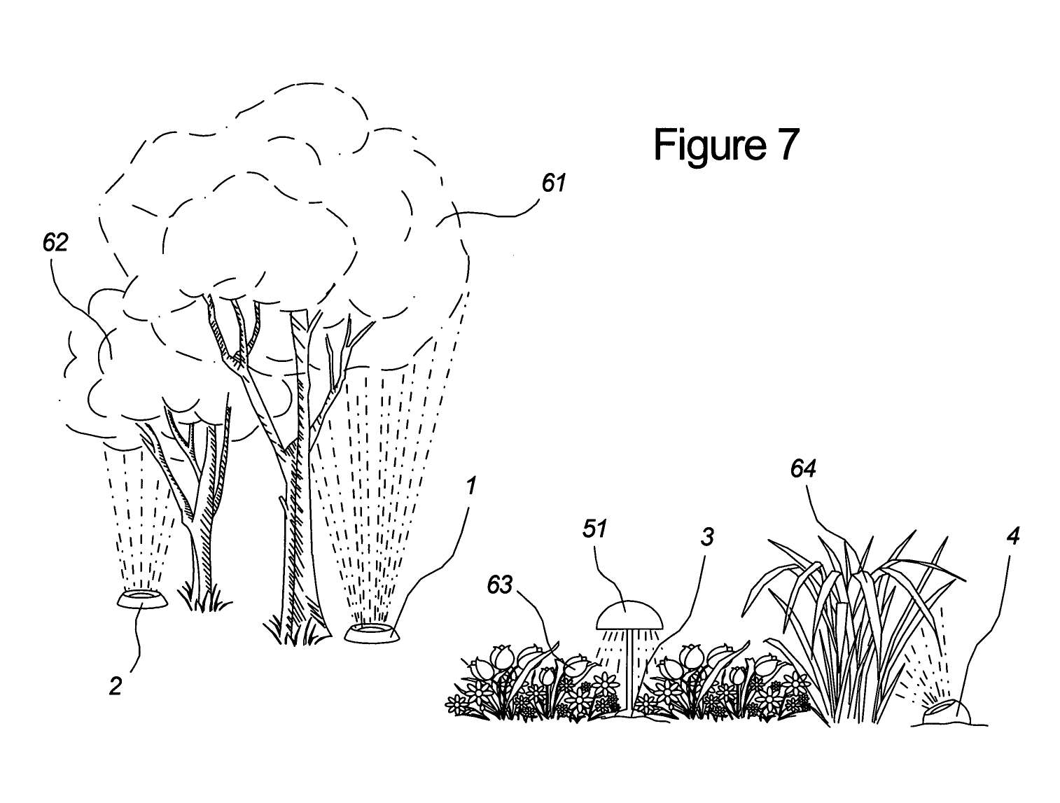

Referring to FIG. 7, the individual lamps 1, 2, 3 and 4 are pre-set at different levels of brightness. Lamp 1 is set at maximal brightness to illuminate a tall tree 61. Lamp 2 is set at a medium level to illuminate a shorter tree 62. Lamp 3 is set at a moderate level to illuminate a flower bed 63 via a mushroom-shaped shade and reflector 51. Lamp 4 is shown buried at an angle to illuminate an adjacent upright plant 64.

Referring to FIG. 8, the weatherproof outer case 80 encloses the control module board FIG. 4-36. Power is conducted from the power supply transformer (120 volt AC) FIGS. 1A & 1B-100 along extra-low voltage secondary transmission conductors 81 to input terminals J3, J4 (also shown in FIG. 2) of the control module board FIG. 4-36, at +/−24 volts AC. The rotary dimmer control 83 mechanically connects to the control module board FIG. 4-36, which is enclosed in the weatherproof outdoor case 80. An O-ring (not shown) prevents the egress of moisture past the rotary dimmer control 83. The rotary dimmer control 83 makes mechanical rotational contact with pot in FIG. 2-RV1. The extra-low voltage power conductors 82 are connected to the output terminals J1, J2 (also shown in FIG. 2), and are then connected to the lamp FIG. 3-23 within the fixture housing FIG. 3-21, allowing for dimming to take place.

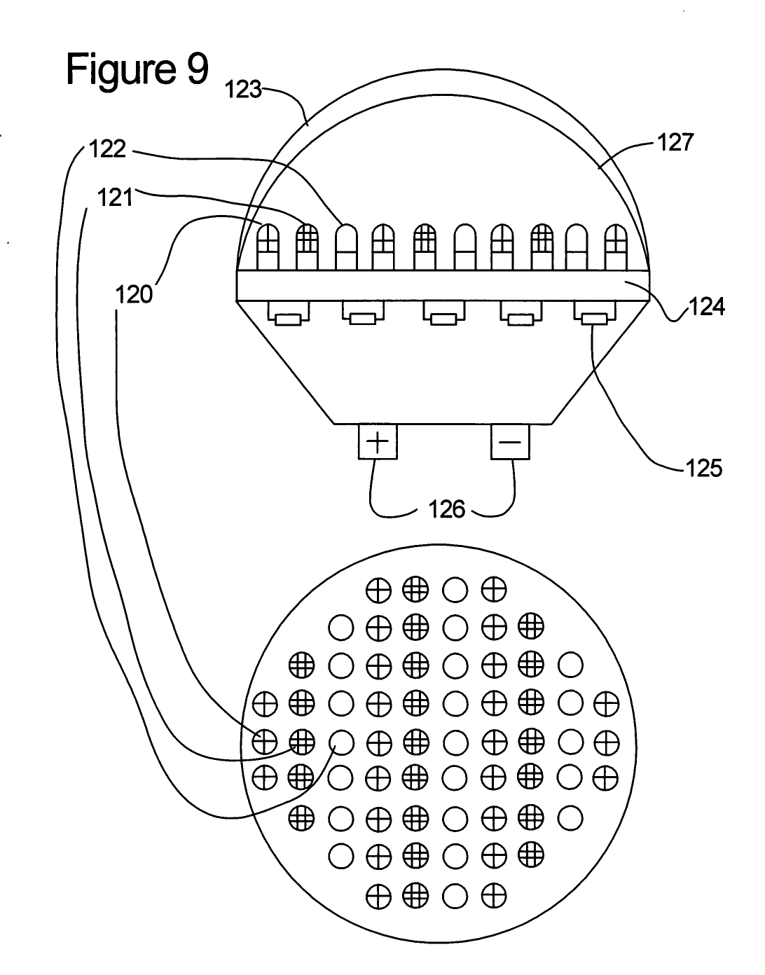

FIG. 9 illustrates the layout of the par 36 LED lamp 127 with 12 white, 12 red and 12 yellow emitters (120,121,122). The emitters are cooled by a heat sink 124. Resistors 125 are in series protecting diodes 120, 121, 122. Spade input terminals 126 are shown with polarity. Also shown is the glass refractory lens 123. The configuration of three colour emitters through the glass refractory lens results in a softer lamp output.

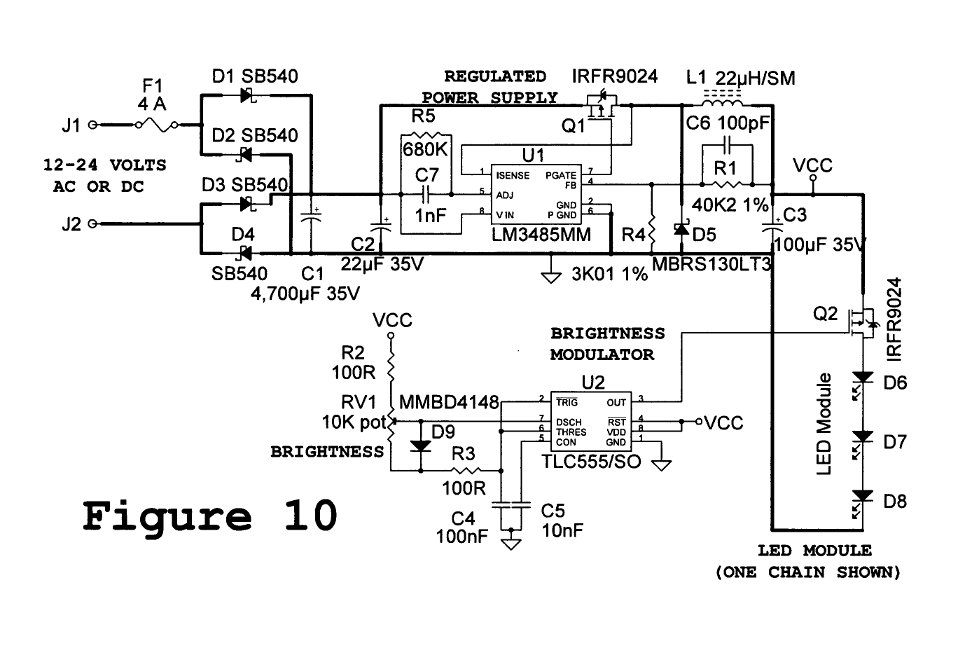

FIG. 10 illustrates the control module circuitry for usage with an LED lamp (hereafter referred to as the LED control module), comprised of two blocks:

U1 and associated circuitry comprise a step-down power regulating supply to produce an output of 10.5 volts at up to 4 amps, which makes possible the dimming of LED lamps up to 42 watts total power.

U2 and associated circuitry is the brightness modulator circuit, which produces an output signal at approximately 1,400 Hz, which is then used to control the LED brightness. In the control module embodiment for usage with an LED lamp, it is the average current that affects lamp brightness.

Referring to FIG. 10, a diode bridge consisting of D1-D4 is used on the power input to allow operation from AC and polarity protection on DC. The power supply circuit will provide a steady output voltage over a range of 12 to 32 volts input. The output is currently set at 10.5 volts but this may require changing dependent upon the final choice of LED control module. For reliability, it is important not to exceed the current rating of the LEDs, and by providing a regulated voltage to match the running voltage of the LED control module, this can be achieved.

Control of the LED brightness is achieved by varying the on-off time of the LED control module and hence the average current. Power to the LED module passes through FET Q2 whose gate is controlled by the brightness modulator circuit around U2. Q2 is turned on and off around 1,400 times a second, which is more than fast enough to ensure that there is no perceived flicker. Unlike a halogen lamp, LEDs turn on and off instantly. The on-off period (duty cycle) of the brightness modulator can be changed through 1 to 99%, which will vary the brightness from almost zero to almost maximum. Fine tuning of the brightness limits can be achieved by increasing the value of components R2 and R3.

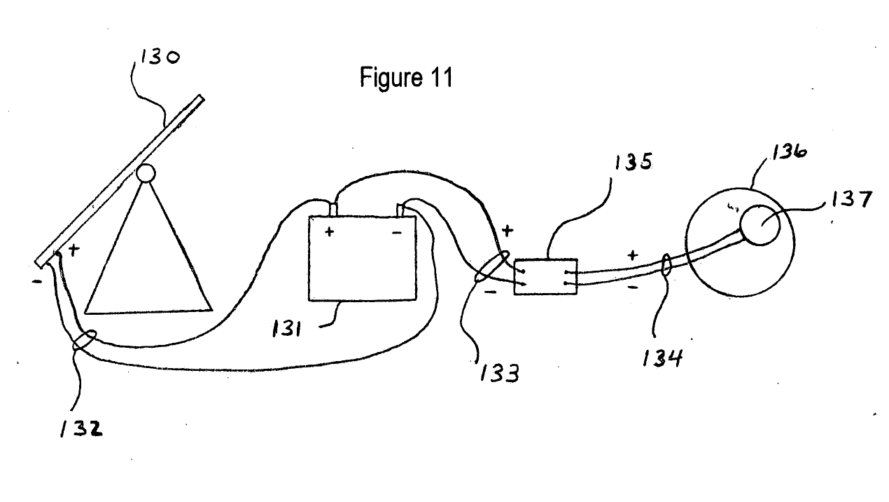

FIG. 11 illustrates a solar power embodiment of the system wherein the solar panel 130 during daylight hours collects energy from the sun and distributes this energy through power conductors 132 to the battery 131 during operating hours. As shown, the energy stored in the battery runs through feeder conductors 133 to the control module 135. The control module 135 sends power to the lamp 137 inside the fixture 136 through fixture conductors 134, from 12 volts DC and below. In this embodiment all voltage is DC. The control module 135 could also be located within the fixture 136. The control module protects the lamp from over-voltage that can exist in the battery rated for 12 volts. During charging, the voltage between the battery anode and cathode can range above 13 volts. After a full charge the voltage across the battery is often 13 volts or more. Again the control module protects the lamp resulting in less material waste.

In a common embodiment of alternate energy, the batteries are arranged as for a 24 volt configuration. As above the battery voltage ranges above 25 volts DC, the control module regulates voltage to the lamp for safe operation of 12 volt fixtures.

The within-described invention may be embodied in other specific forms and with additional options and accessories without departing from the spirit or essential characteristics thereof. The presently disclosed embodiments are therefore to be considered in all respects as illustrative and not restrictive, the scope of the invention being indicated by the appended claims rather than by the foregoing description, and all changes which come within the meaning and range of equivalence of the claims are therefore intended to be embraced therein.

We claim:

1. A system of lighting for energy saving and for providing variably lighted landscapes and walkways, enabling end-users to install and create variable intensity outdoor lighting effects without the use of 120 volt alternating current (line voltage) fixtures, without running line voltage power transmission conductors or extension cords in moist and difficult ground conditions, and without needing skilled electricians, electrical permits, or extensive excavation to line voltage electrical codes, in which an over-voltage power supply is provided from an extra-low voltage outdoor transformer through a control module and then to an under-voltage extra-low voltage outdoor light fixture.

2. The system of lighting of claim 1, in which the control module first rectifies, then regulates, and then can be made to dim the power supplied to the extra-low voltage light fixture.

3. The system of lighting of claim 1, in which power at 24 volts AC is supplied along an electrical conductor that would typically be used for 12 volts, and is then stepped down by the control module to 12 volts DC to the light fixture, whereby voltage drop and power loss over the electrical conductor is approximately halved.

4. The system of lighting of claim 1, in which in addition to stepping power supply voltage down from 24 volts AC to 12 volts DC, the control module provides for selectable further reduction of voltage to the fixture as desired for dimming lighting effects and further energy savings.

5. The system of lighting of claim 1, in which a plurality of lights are connected in a circuit, provided that aggregate current draw by the light fixtures does not exceed the capacity of the control module.

6. The system of lighting of claim 1, in which a supply voltage used in the system for power transmission is 24 volts AC rather than 12 volts AC, whereby power would be saved over using 12 volts AC for power transmission over a distance, given an equal light output and equally sized power supply conductors.

7. The system of lighting of claim 1, in which an extra-low voltage control module including an outdoor extra-low voltage lighting regulator, rectifier, and dimmer operating exclusively between 4 and 30 volts, is used.

8. The system of lighting of claim 1, in which the control module is encased in a weatherproof housing and has an accessible dimming control which can be used to further reduce power consumption from 12 volts DC down and enhance outdoor lighting effects

9. The system of lighting of claim 1, in which the control module is supplied with voltage that is greater than 11 volts via transmission cables that are supplied with the highest voltage that applicable electrical codes will allow, typically 30 volts, for extra-low voltage applications.

10. The system of lighting of claim 1, in which the control module will bring down by means of voltage regulation, a supplied voltage to 12 volts, which is industry standard, effectively creating a transmission line effect of power supply conductors.

11. The system of lighting of claim 10, in which the control module can further reduce voltage by means of an accessible dimming control from 12 volts DC down.

12. The system of lighting of claim 1, in which the control module when properly supplied will ensure that maximum voltage is supplied to each light fixture and only then will the voltage, be fed to a dimmer in order to enable the most widely variable desired light effect in extra-low voltage at the light fixture.

13. The system of lighting of claim 1, in which a dimming control will reduce voltage for the sake of dimming and energy savings down from 12 volts DC to a light fade out voltage of a extra-low voltage fixture light and back up to full voltage (12 volts) repeatedly as selected by an end user.

14. The system of lighting of claim 1, in which the control module will fit inside a substantially spherical light fixture with or without a convertible mushroom cap.

15. The system of lighting of claim 1, in which the light fixture allows for rapid conversion from up-light to down-light by means of a tube and a mushroom shaped canopy.

16. The system of lighting of claim 1, in which the light fixtures have multi-colored LED lamps which when combined can be made to imitate the light output of a halogen lamp and when dimmed retain the same color as with full power, whereby more energy may be conserved.

17. A system of lighting claim 1, in which a DC power supply feeds current to the control module between 12 and 30 volts DC, the control module protecting a lamp in the light fixture from over-voltage.

18. The system of lighting of claim 2, in which:
a) power at 24 volts AC is supplied along an electrical conductor that would typically be used for 12 volts AC, and is then stepped down by the control module to 12 volts DC to the light fixture, whereby power loss over the electrical cable is approximately halved;
b) in addition to stepping power supply voltage down from 24 volts AC to 12 volts DC, the control module provides for selectable further reduction of voltage to the fixture as desired for dimming lighting effects and further energy savings;
c) an extra-low voltage control module including an outdoor extra-low voltage lighting regulator, rectifier, and dimmer operating exclusively between 4 and 30 volts AC and DC, is used;
d) in which the control module is encased in a weatherproof housing and has an accessible dimming control which can be used to further reduce power consumption from 12 volts DC down and enhance outdoor lighting effects;
e) the control module will fit inside a substantially spherical fixture with or without a convertible mushroom cap;
f) the light fixture allows for rapid conversion of from up-light to down-light by means of a tube and a mushroom shaped canopy.

19. The system of lighting claim 1, further comprising an LED control module for the dimming of multi-color LED lamps.

20. The system of lighting claim 1, in which a multi-color LED lamp comprises red, yellow and white emitters to simulate halogen light and has a glass refractory lens to provide a substantially homogenous blending of colours.
